(19) United States
(12) Patent Application Publication
(10) Pub. No.: US 2009/0311654 A1
(43) Pub. Date: Dec. 17, 2009

(54) Multistage Automatic Coaching Methodology

(76) Inventor: Pedro Amador Lopez, Madrid (ES)

Correspondence Address: Lauson & Tarver LLP, 880 Apollo Street, SUITE 301, El Segundo, CA, 90245, US

(21) Appl. No.: 12/140,199

(22) Filed: Jun. 16, 2008

(51) Int. Cl. G09B 19/00

(52) U.S. Cl. 434/238

(57) ABSTRACT

A method and system of providing computer based life coaching comprising the steps of: providing an interface that allows a user to valuate their present level of happiness in a series of broadly defined areas of life; including money, leisure, love, physical environment, professional development, friends and family, health, and personal growth. Once levels of happiness are obtained in each of these areas, a chart is created to determine which areas are of lowest satisfaction and address them. The system then prompts a user to establish factors related to each area of happiness and evaluate those factors in terms of importance level. Subsequently, the user is prompted to select various changes related to the factors and areas. Once the changes are selected, a description of the user after the changes occur is generated and supplied to the user.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Coaching is known in the art, as is life coaching. However, coaching currently necessarily involves the interaction of one person (the coach) with another person (the person being coached). This process requires the active participation of both parties, and usually requires them to be in close contact. Therefore there is a need for a coaching system that can be carried out by the person being coached, and which enables the person being coached to automatically go through the coaching process.

It is therefore an object of the present invention to provide a coaching system that is computer based and automatic. A further object of the present invention is to allow a person seeking coaching to identify areas of his life with which he is unhappy. Another object of the invention is to provide a system of identifying factors related to the happiness of a person in various areas of his life, and to select changes to be made in these areas based on those factors. Finally, it is an object of the present invention to provide a hypothetical definition of the levels of happiness of a person at a predetermined point in the future once all the changes have been adopted.

### SUMMARY

A system of automatic coaching that enables users to identify their level of happiness in various areas of life, isolate factors that influence happiness in those areas, and select changes that can improve their happiness in areas with a low happiness measurement.

The system is broken down into five stages. The first stage is chart creation, wherein a chart is created by a user that defines their relative happiness in a variety of aspects of their life. Factor identification is used to identify factors that affect the level of happiness in a specific aspect of the user's life. Factor management is used to evaluate the selected factors by level of importance. The system suggests changes to be made along with managing the accomplishment of those changes. A database containing a predetermined list of possible factors and possible changes is used to guide users through factor selection, factor management, and the implementation of changes. The predetermined factors and changes are organized and linked so that the selection of a factor leads logically to further predetermined factors related to the initial factor, and eventually to a specific change governed by the factor and change selection process. Finally, as the factors and changes are selected and implemented, the system creates an outline of the characteristics of the user in the future where the long term objectives of the user are specified.

### FIGURES

FIG. 1 is a diagram of the overall system of the present invention, including the stages a user goes through to engage the system.

FIG. 2 is a diagram of the overall happiness of a person, represented by a pie chart, with different areas of happiness scored independently.

FIG. 3 is a diagram of possible changes that could be made in a work environment and a reward for the changes.

FIG. 4 is a table showing some of the factors of the present invention.

FIG. 5 is a table showing the functional relationship of some of the factors of the present invention.

FIG. 6 is a table showing some of the changes of the present invention.

FIG. 7 is a table showing the functional relationship of some of the factors of the present invention.

FIG. 8 is a table showing the relationship between the factors and the changes of the present invention.

### DESCRIPTION

The present invention comprises a system of automatic coaching that enables adult users to identify changes that can improve their lives. The changes are designed to enable users to achieve long term objectives according to the creation and definition of a user in the future after the changes have taken effect.

The objectives of the present invention are to give users support for their achievement of happiness, wherein this achievement is divided into two parts: obtaining a predetermined level of self-knowledge allowing the user to valuate the factors necessary for happiness in the short run, and identifying the changes that are necessary in the long run to achieve factors corresponding to a users image of himself in the long term future.

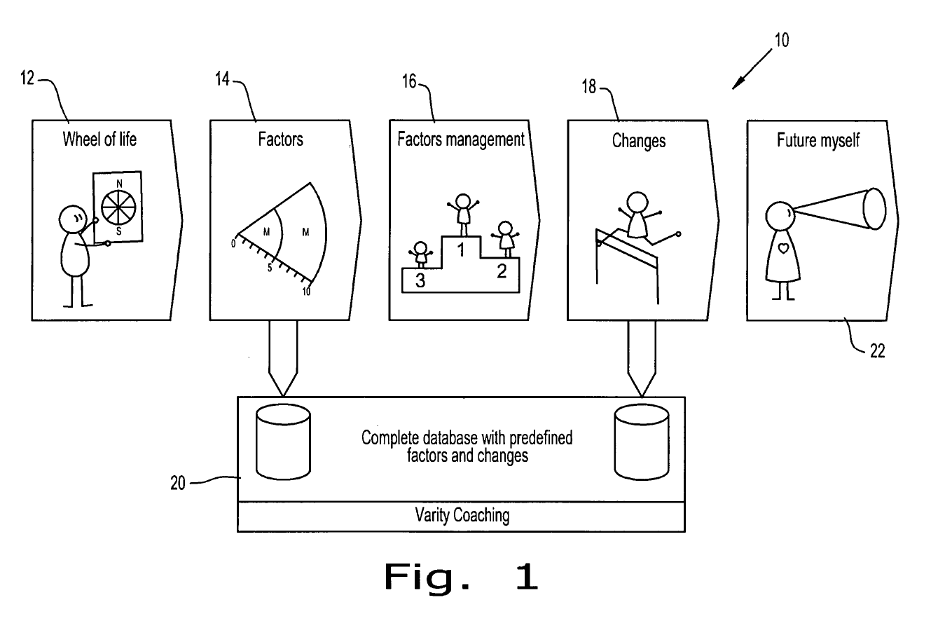

Referring to FIG. 1, the methodology 10 of the overall system is broken down into five stages. The first stage is chart creation 12, wherein a chart is created by a user that defines their relative happiness in a variety of aspects of their life. Once the chart is created, factor identification 14 is used to identify factors that affect the level of happiness in a specific aspect of the user's life. Once factors are identified, factor management 16 is used to evaluate the selected factors by level of importance. After the factors are selected and evaluated, and based on the user's evaluations, the system suggests changes 18 to be made along with managing the accomplishment of those changes. A database 20 containing a predetermined list of possible factors and possible changes is used to guide users through factor selection, factor management, and the implementation of changes. The predetermined factors and changes are organized and linked so that the selection of a factor leads logically to further predetermined factors related to the initial factor, and eventually to a specific change governed by the factor and change selection process. Finally, as the factors and changes are selected and implemented, the system creates an outline of the characteristics of the user in the future 22 where the long term objectives of the user are specified.

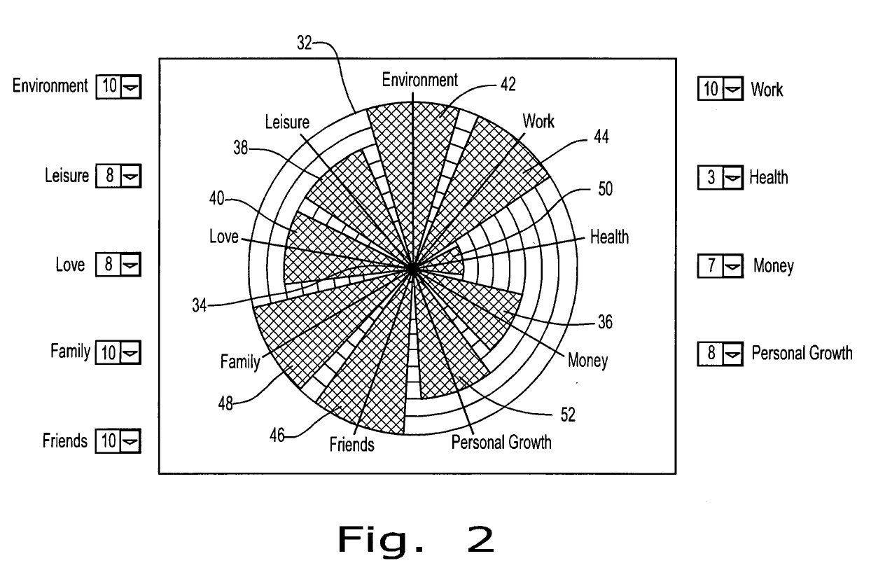

Referring to FIG. 2, the happiness of an individual is broken down into different areas of life and each area scored from 0 to 10. Happiness in various aspects or vital areas of life is equidistantly distributed in a pie chart 30. The outer part of the chart 32 represents the highest score (10), and the center of the chart 34 represents the lowest score (0). All of the arcs have the same dimensions regarding width and ratio. Each arc shows the level of satisfaction in one of the areas of life, and the totality of the arcs makes up the whole of the aspects of the user's life.

Still referring to FIG. 2, users subjectively evaluate each area. In one preferred embodiment, the areas of life represented on the chart include: Money 36, indicating the satisfaction level that a user's daily management of money provides him. Leisure 38, valuating the free time a user has at his disposal; not evaluating the presence of free time, but rather the quality of time spent. Love 40, valuating a user's current status regarding the search for, willingness toward and enjoyment of love. Surroundings 42, valuating a user's satisfaction with housing, neighborhood, city and country. Professional development 44, valuating the motivation and satisfaction level that a user's career brings. Friends 46 and Family 48, valuating—in two sections—a user's level of happiness in both areas. Health 50, valuating a user's physical and mental strength, and finally Personal Growth 52, valuating a user's level of satisfaction regarding his life.

The appearance of the life cycle wheel is based on judgments made by the user regarding each vital area. The higher an area is valuated, the bigger the portion of the arc will be and as a result, the mark. Once all the areas are valuated, an image is obtained showing the evaluation by the user regarding different aspects of his life. The image captures in an easy and fast manner, the user's strengths and weaknesses of various aspects of his life. By doing this, the user identifies the most problematic areas to be addressed to improve his quality of life.

Once all the areas of a user's life have been valuated and incorporated into a resulting image, the weakest points are detected and a user is encouraged to continue exploring factors affecting each area according to the following scales: If the scores obtained in all areas are superior to 8 or 9, and the user feels satisfied and happy, there is no need to continue with the system. The system does not allow an option to set all values to 0, which is only valid for dead people. The system will allow a user to score every area with 10, but these scores will be considered an overvaluation. Additionally setting the same score for all the areas will impede the ability to select areas that need improving. In these instances, the opinion of an expert is required to check if the valuations are correct.

Appropriately valuated aspects of life can be interpreted as follows: A score of 0-3 shows a significant dissatisfaction level that may or may not require support. Aspects of life scored this negatively may be influencing the rest. A score of 4-6 requires an analysis in order to evaluate the changes needed to fix the aspect. A score of 7-9 indicates that in principle, fast intervention is not required. However, attention should be paid to these points in the event other aspects are valuated inferior to 7. A value of 10 indicates that no action is required. Nevertheless, the accuracy of this score should be checked due to the fact that some users overvalue some aspects of their lives in order to hide something.

In order to address the valuations applied to individual areas of a user's life, factors are used. Factors can be defined as the requirements that need to be met for a user to have satisfaction in each one of the areas of the user's life represented on the chart in FIG. 2.

Factors are unique to different individuals and therefore are not generalized by race, religion or sex, although general conduct patterns may be found. Primarily, the factors are based on the Herzberg hygienic and motivating factors that explain work behavior. Specifically factors can be classified as motivating factors; those factors related to work, for example, recognition, stimulant work and personal growth and development, or as hygienic factors; located within the working environment and which must be satisfactory in order for a person to avoid stress.

As applied to the instant invention, the lowest valuated areas in the aspects of life chart for an individual user indicate areas where factors should be developed first. In order to develop factors for an area of life, a user must: detect the different factors required for each area of life; indicate whether the factors are necessary or motivating; and arrange them in order of importance. In order to indicate factors that are fulfilled at a given moment, the system constantly updates rules in order to indicate the factors that should be addressed first.

The first step in establishing factors related to areas of a user's life comprises listing factors that the user would like to have in each area of the life wheel. In order to create the list, the system database serves as the repository for factors, and contains the rules related to different factors.

In addition to populating a list of possible factors regarding an area of life, the system permits a user to rate the types of factors. The first stage in rating the factors is classifying them as either necessary or motivating. Necessary factors are essential and indispensable requirements that must be present in an aspect of life in order for that aspect to score highly. By contrast, motivating factors are those elements that despite not being essential, contribute to an improvement in the situation.

An example of the distinction between necessary and motivating factors follows: If a person will be living for an extended period in a hotel because of business, some necessary factors would normally be to have a bed and a bathroom with shower and toilet. This would be conventionally understood as the basic needs that must be met, and if not provided, causes stress. By comparison, motivating factors would be amenities that are great if present, but if not, don't really matter; for example a satellite connection, elaborate soap containers, toiletry bags; etc.

Applying this methodology to the present invention, one example is provided regarding job satisfaction. Some of the necessities for a high valuation of career satisfaction are: for an individual's job to have full time working hours, to have a wage that allows the individual to live as comfortable as possible, and to have electric air conditioning equipment at work. Some of the motivators for a high valuation of career satisfaction include: confidence in an individual's skill level, and at least one month of holidays each year.

In addition to classifying factors into necessities and motivators, factors are also classified by users according to their importance level. Once the factors are arranged from less to more important, grades can be assigned to them. Factors that are not fulfilled are causes of stress.

Once composed and classified by importance level, a set of rules is applied to the set of factors. These rules cover three principle areas: First, some motivating factors can supplant necessities. As an example of this rule using the previous hotel example, it was indicated that a hotel, should have a shower as a necessary element. However, if the hotel offered a room with a hot tub, but no shower, the presence of the hot tub would make a person not realize the necessity of the shower.

The second rule is that motivating factors can turn into necessities over time. As an example of this rule using the hotel example, after spending some time in the same hotel the hot tub seems so usual that a person will not be able to go to any hotel without a hot tub.

The third rule is that necessities can turn into motivators over time. This rule is exemplified by the fact that as time passes, some things that once seemed necessary, have stopped being so. These three rules are applied to the factors, so that as a person selects the importance level of a factor, the system can accurately determine how the particular selection governs additional factors contributing to a user's needs in a particular area of life.

Once all factors have been identified and defined according to their level of importance, the system prompts a user to select changes that need to be made in order to satisfy the factors. Changes refer to actions that guide a user to feeling better. Similar to factors, they are individual and cannot be generalized by race, religion or sex.

The component parts of user selectable changes that can be applied to various factors include a description of the change: an objective phrase that is specific and capable of measuring; change options: different forms or ways of being able to achieve the change, while understanding potential obstacles and benefits inherent in a particular type of change; a date: comprising a specific moment by which time the change should have occurred; an a prize: a reward obtained once the change is accomplished. Changes may also be accompanied by reminders that cause a user to remember tasks prescribed by the change; for example a physical note that reminds a user to do something or a reminder in electronic format.

As an example of changes governed by the system, in the context of a health aspect of life rated as a five: To move the health rating to six, a user may commit to lower his daily smoking level from thirty down to ten cigarettes (an objective and measurable result), to remind the user, a post-it (providing structure) is located in the cigarette box that reminds the user of the activity. At the end of the day, the post-it is recorded and a new one for the next day created. The commitment is that by smoking a certain lower quantity of cigarettes each week, in ten weeks the user will have reached his goal. A prize is then obtained: for instance a holiday at the user's favorite destination.

Changes are created and followed up according to the following guidelines: A change is selected that is designed to satisfy the factors governing a particular life area; the change and others are assigned a rank according to their level of importance; and a follow up to the change is created for determining that the change brought about the desired result.

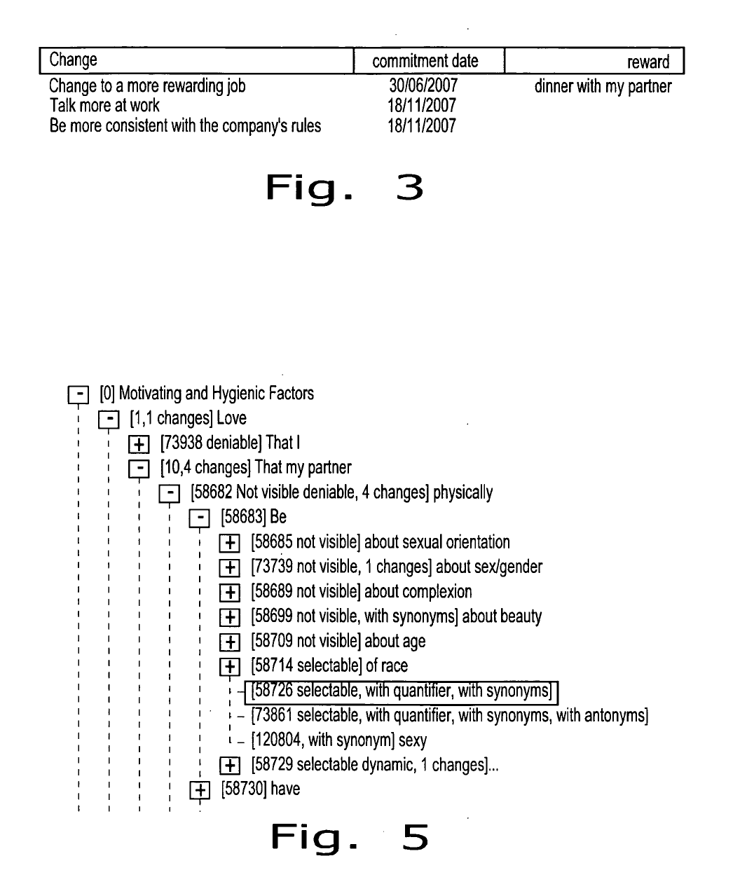

Referring to FIG. 3, a possible list of changes at work are provided. In the event that changes are not accomplished, users are directed to analyze the causes that have prevented success and why the possible commitment date was put there. If a user fails a few times in achieving a change, he is directed to consult with a coach or psychologist in order to detect the real preference compromise motivation related to the change.

By selecting from a predetermined list of factors, including selections for ranking the factors that lead to happiness in an area of life, and by selecting from a predetermined list appropriate changes to achieve those factors, including ranking the changes according to level of importance, the system is able to generate a description of the user in the future that comports with the changes the user wishes to make, wherein the user is happier in the areas of his life that need improvement. This is designed to represent long term goals with a horizon of ten to twenty years. The description of the user in the future is based on wishes written in paragraph format designed to avoid generalizations (e.g. “I want to be happy”, “I want money”, “I want to be healthy”).

The description of the user in the future is developed by creating an initial description through the use of the system, and updating the description by re-analyzing various aspects of life, and re-establishing factors contributing to happiness in these areas, and the changes necessary to increase happiness. Although factors and changes can be dynamic, over time, the definition of the user in the future should become as stable as possible. Therefore if a user wants to accomplish change in a short period of time, he is recommended to seek a coach or psychologist in order to define a better future strategy.

The process of selecting factors and changes is accomplished in the present system by using a method, herein described as “variety coaching.” Variety coaching is a computer based hierarchical system structured with factors and changes already selected that help the client to detect and select additional factors and changes. Variety coaching can be defined as the group of variations produced by the system to help a client detect factors and changes.

The variety coaching process uses a personalized and dynamic database, which is dynamic because it provides users with the ability to include new factors and changes that were not present at the beginning. The system comprises a taxonomic system with consistent rules to improve the client's options. Initially, the system is provided with 70,000 factors and 10,000 changes that apply to satisfaction in the various life areas identified above. Additionally, it has two data structures, one that connects various factors together and various changes together; and another structure that connects factors to changes.

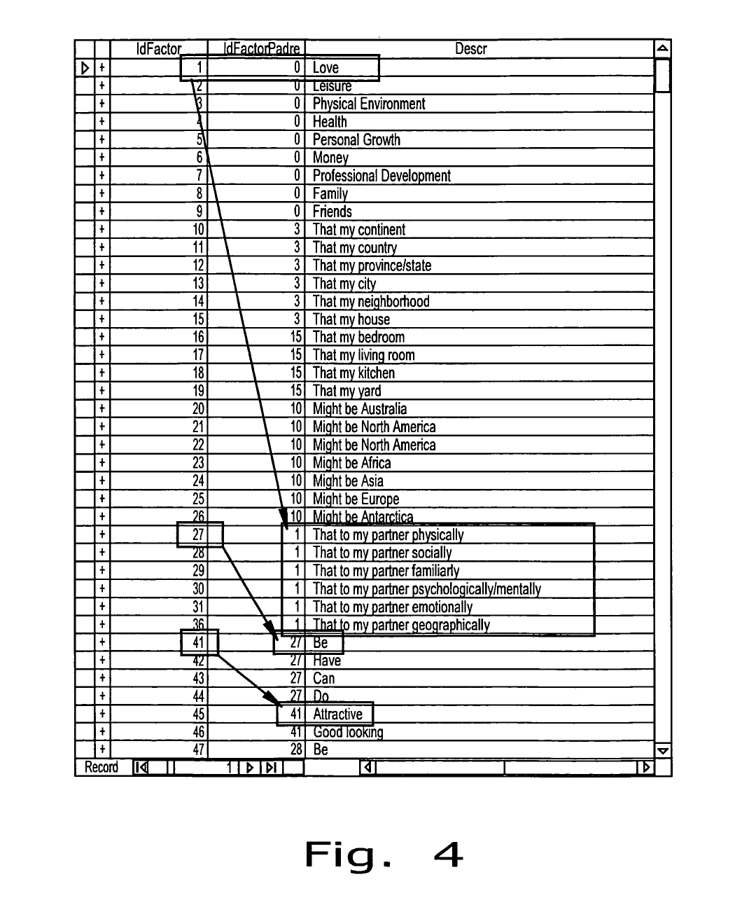

Referring to FIG. 4, the structure of a table 58 of factors is shown and described. The set of options that are offered to the client as factors are stored in a database in which each register made is a part of a suggested factor phrase and has an independent/dependent structure so that not all the registrations are valid options to be used by the user at any given time. Each registry from the factor table has the following attributes: A “Factor ID” 60 identifies the branch of each factor; An “Independent Factor ID” 62 references factors that are at the base of all factors, namely, the first node derived from the various life areas identified by the system. “Node Description” 64 describes each factor. “Selectable” 66 indicates if the individual factor can be selected depending on other factors governing it. “Synonyms and Antonyms” (not shown) indicate possible synonyms and antonyms associated with a factor.

In order to formulate factors for a predetermined area of life, the database is loaded and Factor IDs 60 factors dependent on the first nine Independent Factor IDs 62. Each Factor ID 60 leads to further dependent Factor IDs 62 until no more Factor IDs are selectable.

Referring to FIG. 5, the functional structures of the factors is shown. According to the diagram, the notes point out the following Node1 70 corresponds to the broadly defined sections of the areas of life. Node2 72 corresponds to the first division usually presented by the factor. Node3 73 is normally a verb that explains action related to the factor, and additional nodes continue until the end of the factor is reached. The different nodes represent linguistic partitions pertaining to the factors. For instance “help me find my qualities” or “help me see my limitations” would be split first into “help me,” and then into “to find my qualities” or “to see my limitations.”

Additional rules pertaining to the factors are as follows: A space is left between node descriptions, unless the description starts with a dash, in which case no space is left. For example, the factor affecting the happiness score pertaining to love might include text indicating: “Love/that my future or present partner is/-are several” would be translated as “that my present or future partners are several.” G. Love/that my future or present partner/is/-are several, this would be “that my present or future partner are several”. No node should have more than 10-12 dependent nodes under it; if it does then they should be put in a group (creating another level). Likewise no node should have only 2 dependent nodes. In this case, the two dependent nodes should be moved up one level. Finally the node definitions are designed to avoid node repetition. For example: “Family/For my partner/to be/attractive” would automatically be linked to the factors linked to “Love/For my partner/to be/attractive.”

Structure of “Changes” in the database. The changes chart has a father-son structure the same as the factor chart, but with one difference, the factor chart continues linking information with each node that is inserted (e.g. Love/for my partner . . . ). By contrast, in the changes chart, each node is independent, but receives the changes from their father changes.

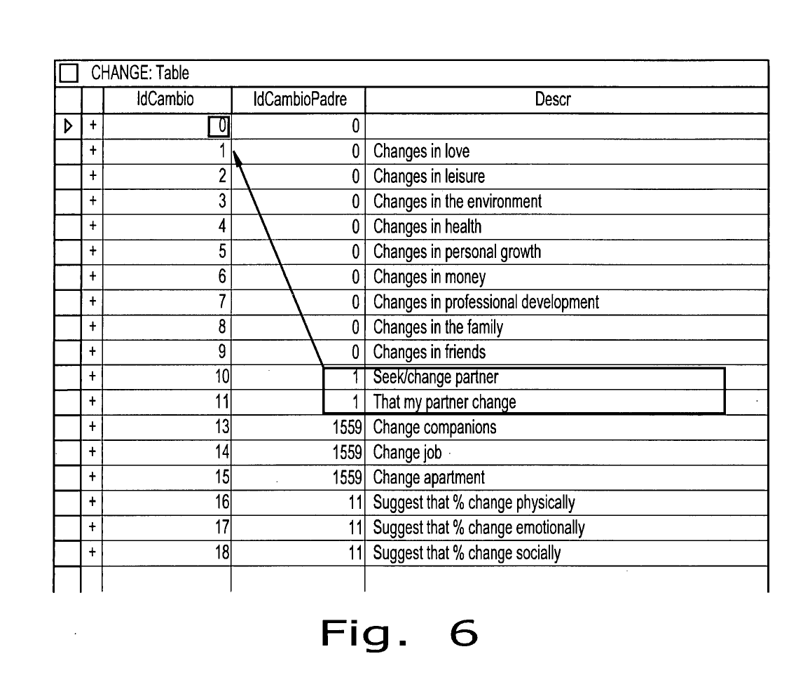

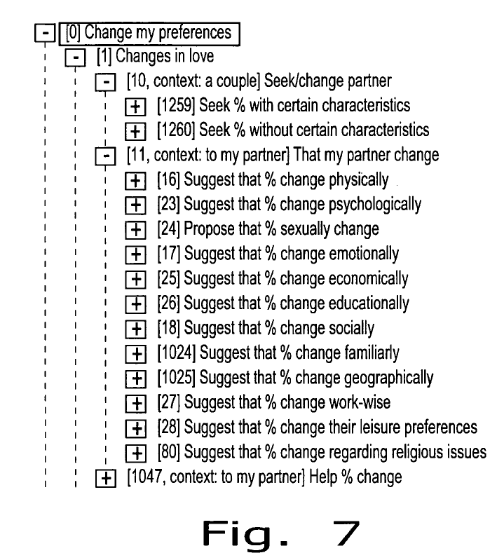

Referring to FIG. 6, “Id Change” 80 is the only identifier in each change branch; “Id Change Father” 82 is the reference given to the identifier that is the father, being 0 in the case of the first node without a father; “Descr0” 84 describes the change; and “Context” 86 indicates the phrase or word to be used when you come across the symbol % in the description. For example the change “Find %” with a determined number of characteristics, has to include the context “a partner,” “some friends,” etc. If the change doesn't include a context, it will go on to the next father that does have it. This will permits designers to clone changes and reduce complexity in the database.

Still referring to FIG. 6, in order to formulate a description of a change, it is necessary to load all the charts, and from some of the sons belonging to the nine first fathers (the Id Change Father=0) until the very last son, a user is able to obtain all the possible changes in each register of Descr0. This creates a father-sun structure for all the changes, but in this case it doesn't have to reach the final son node to make sense, because all the way from the father to the last son they make sense by themselves.

Referring to FIG. 7, the functional structure of the changes is shown and described. In a functional level, you can obtain the following data from the changes According to the figure, the nodes give the following information: Node 1 or Father 90 gives the generic change, Node 2 92 comprises a generic change in each part or section, and node 3 94 shows the biggest detail of the change suggested

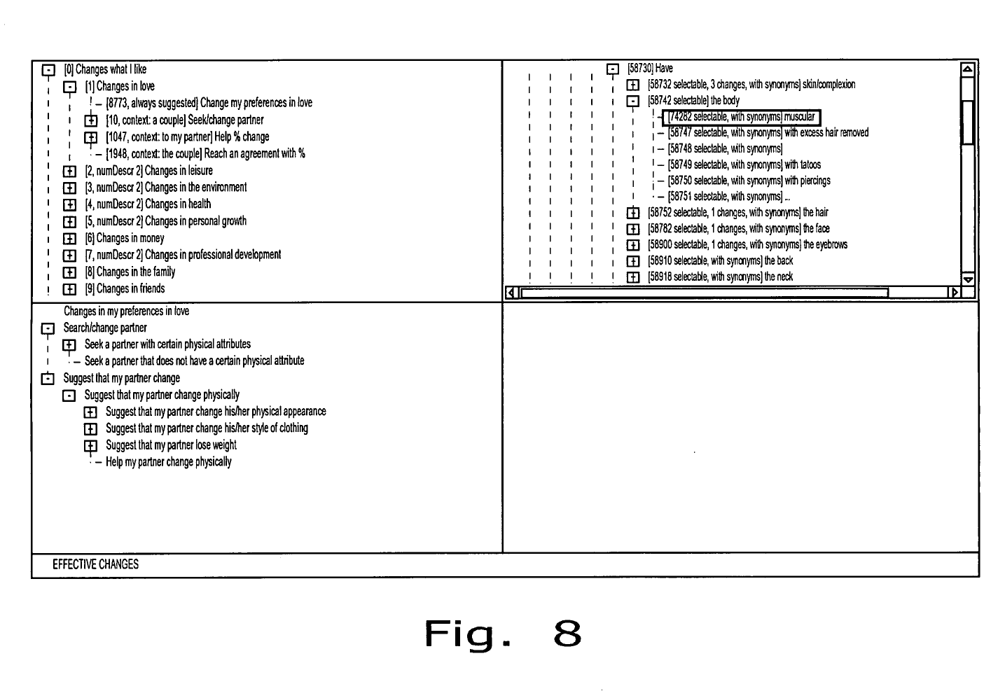

Referring to FIG. 8, a factors to changes structure is shown. It is necessary to specify for each database factor the related changes recommended by the system in case it doesn't satisfy that factor. For example, the parts carried out for the factor “for my partner to have a strong body”, are related to the different possible changes related to this factor: “changes in love,” “change my tastes in love,” “find/change partner,” etc.

The databases comprise the nodes, their description, and synonyms—if any—separated from the description by quotations. The database also includes antonyms. For example; The structure of the “Love” life areas divided in each of the next three levels: first, the selection of a preference concerning the user, such as “That I”. Then the selection of a preference concerning a partner, such as “That my partner.” Then selecting attributes such as fiscal, sexual, psychological, emotional, economical, educational, social, working, family, geographic, leisure or religious conditions, and finally choosing a preference concerning day to day living.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved methodology of providing automatic coaching services using a computerized medium, comprising the steps of;
a. a user valuating their level of happiness in a variety of areas; including money management, quality of leisure time, romantic satisfaction, physical environment, relationships with friends and family, health and level of personal growth, wherein the areas are assigned a numerical value, and that numerical value is used to create a visual representation of happiness in all these areas;
b. a computer medium applying a scale to the numerical values;
c. a computer medium detecting the weakest of the areas identified by the user;
d. a user identifying a series of factors used to determine the numerical value of each area;
e. classifying the factors as either necessary or motivating;
f. arranging the factors in order of importance and evaluating them;
g. identifying changes that are necessary to satisfy the factors, wherein changes comprise a description of the change, different ways of accomplishing the change, a date for completing the change, a price for completing the change, and structures or reminders for the task of changing; and
h. wherein a database containing hierarchical lists of factors and changes are provided and associated, so that when a factor or change is selected, a predetermined set of messages regarding and further refining the factor or change is provided to the user; wherein a definition of the relative change in happiness of the user after the changes take place is provided to the user.

2. The system of claim 1, wherein the happiness values for different areas are described in a pie chart wherein each area pertains to a section of the chart, and each section of the chart demonstrates the corresponding value of the area by the distance from the center of the chart.

3. The system of claim 1, wherein if the scores are 8-9 in all areas, the user is instructed to discontinue the process.

4. The system of claim 2, wherein the pie chart represents the happiness of each individual, breaking grades of happiness down into scores of 0 to 10.

5. The system of claim 4, wherein all the arcs in the pie chart show levels equally, so that when all areas have the same level of satisfaction, a perfect circle is created.

6. The system of claim 1, wherein the factors comprise requirements users would like to have satisfied in each area of potential happiness.

7. The system of claim 6, wherein factors are broken down into motivating factors and necessary factors.

8. The system of claim 7, wherein the factors are ranked according to level of importance.

9. The system of claim 7, wherein motivating factors cover necessities in at least one instance.

10. The system of claim 7, wherein motivating factors are converted to necessary factors in at least one instance.

11. The system of claim 7, wherein necessary factors are converted to motivating factors in at least one instance.

12. The system of claim 1, wherein changes comprise; a description of the change, suggested ways of achieving the change, the anticipated date of completion of the change, and a reward for completing the change.

13. The system of claim 12, wherein reminders are scheduled to remind a user to affirmatively act or refrain from acting to accomplish a change.

14. The system of claim 12, wherein changes are designed to address a predetermined factor, arranged by rank according to level of importance, and evaluated after a predetermined time for auditing purposes.

15. The system of claim 1, wherein the definition of the happiness of the user is designed to reflect changes in the user over the course of ten to twenty years.

16. The system of claim 1, wherein factors are arranged in hierarchical taxonomic order in a database, so that factors depend on parent factors relating to one of the areas of happiness, and wherein only related factors are selectable from the factors upon which they depend.

17. The system of claim 1, wherein changes are arranged in hierarchical taxonomic order in a database, so that changes depend on parent changes relating to the satisfaction of various factors, and wherein only related changes are selectable from the changes upon which they depend.

18. The system of claim 1, wherein the database links factors related to changes, so that related factors and changes can be selected.
